(19) United States
(12) Patent Application Publication
(10) Pub. No.: US 2017/0003993 A1
(43) Pub. Date: Jan. 5, 2017

(54) File Based License Management System in Virtualization Environment

(71) Applicant: SIEMENS AKTIENGESELLSCHAFT, Munich (DE)

(72) Inventors: Siyuan Zhou, San Diego, CA (US); Livio Dalloro, Princeton, NJ (US); Michael Wieczorek, Erlangen (DE); Rick Eigenmann, Ottersheim (DE); Ralf Mildenberger, Schutterwald (DE); Yacine Badiss, Casablanca (MA)

(21) Appl. No.: 14/771,556

(22) PCT Filed: Mar. 5, 2014
(86) PCT No.: PCT/US14/20486

§ 371 Date: Aug. 31, 2015

Related U.S. Application Data
(60) Provisional application No. 61/773,290, filed on Mar. 6, 2013.

(51) Int. Cl. G06F 9/455; G06F 21/10

(52) U.S. Cl. CPC G06F 9/45558; G06F 21/10; G06F 2009/45591

(57) ABSTRACT

A system for managing software application licenses includes a physical machine (10) including computer system hardware. A hypervisor operates on the physical machine. A plurality of application virtual machines (11a, 11b) are instantiated on the hypervisor. Each of the plurality of application virtual machines executes at least one licensed software application (12a, 12b) and a local license manager (13a, 13b) for managing a license file of the licensed software application. A master license manager (15) executes on the physical machine. The master license manager is configured to receive the license files (16) of the licensed software application from the local license managers of each of the plurality of application virtual machines.

### CROSS-REFERENCE TO RELATED APPLICATION

The present application is based on provisional application Ser. No. 61/773,290, filed Mar. 6, 2013, the entire contents of which are herein incorporated by reference.

### TECHNICAL FIELD

The present disclosure relates to license management and, more specifically, to a file based license management system in a virtualization environment.

### DISCUSSION OF THE RELATED ART

Software is often licensed for use by an application developer to an end-user. The software license is a legal construct that defines the ways in which the end-user is entitled to utilize the licensed software. License management systems have been used by application developers to ensure compliance by the end-user with the terms of the software license.

While there are many different forms of license management systems in use today, most conform to one of three general categories. The first category relies upon the presence of a hardware dongle. Today the hardware dongle is often connected to a computer via a USB port. The hardware dongle contains circuitry and/or data that the software looks for prior to execution. If the software successfully locates and validates the hardware dongle then the software will execute normally. However, if the hardware dongle is not found or cannot otherwise be validated then execution may be prevented.

Another category of license management involves the use of a license server. The license server may be maintained either by the application developer or by an enterprise that includes a large number of end-users. The software may then contact the license server over a computer network such as the Internet or an enterprise intranet and attempt to authenticate the software license. The license server may thereafter verify that the terms of the software license are being followed and then may permit the software to execute. This approach, however, may rely upon a network connection between the computer of the end-user and the license server. For example, the computer of the end-user may have to be connected to the Internet in order for the software to be allowed to execute.

The third category of license management involves the use of a license file stored locally on the computer of the end-user. A license manager application executing on the computer may then check for the presence of a valid license file prior to allowing the application to execute.

Regardless of the category of license management system being used, the license manager, license server, or even the hardware dongle, may attempt to match a hardware fingerprint of the computer against a set of authorized hardware fingerprints. The hardware fingerprint may be created based on the hardware elements present on the computer such as a hard disk identifier or an Ethernet (MAC) address.

While each of the above-identified approaches for license management may have its advantages and disadvantages, the emergence of virtualization has created a problem for license management.

Virtualization is the concept where a single computer, identified herein as a “physical machine” may run one or more virtual environments, identified herein as a “virtual machine” (VM). When not using virtualization, a computer may run an operating system and upon the operating system, one or more applications may be executed. The operating system thereby handles communication between the applications running thereon and the hardware elements of the computer.

When using virtualization, the physical machine may run a hypervisor. A hypervisor is a software or firmware program that creates a virtual machine on a host computer. The hypervisor may also be called a Virtual Machine Manager (VMM). The hypervisor may run directly upon the physical machine without the need of a distinct operating system running directly on the physical machine, or alternatively, an operating system may run on the physical machine and this operating system may execute the hypervisor. The hypervisor may create one or more VMs and each VM may run an operating system and one or more applications thereon. The operating system of the VM, however, does not directly handle communication between the applications running thereon and the hardware elements of the physical machine, rather the hypervisor creates the presentation of virtual hardware and the operating system running on the VM handles communication between the applications running thereon and the virtual hardware. The hypervisor then manages the physical resources of the physical machine to allot these resources to the virtual machines as needed. The operating system of the VM, however, need not know that it is running on a virtual machine, as the hypervisor's presentation of the virtual hardware may look like physical hardware from the point of view of the operating system running in the VM.

License management systems may not work effectively on a virtual machine. For example, if the managed software application is running on a VM and a hardware fingerprint is created, the hardware fingerprint may be created based on virtual hardware and therefore the hardware fingerprint of the VM may not match the hardware fingerprint of the physical machine on which it runs. This may lead to a case in which the software application is prevented from running, even though the physical machine is indeed authorized to run the software. Conversely, because the fingerprint of a VM is based on virtual hardware, if a VM is authorized to execute the software application, then the VM may be freely copied and run on different physical machines, each of which may then be able to run the software application, even though it is not running on authorized hardware.

### SUMMARY

A system for managing software application licenses includes a physical machine including computer system hardware. A hypervisor operates on the physical machine. A plurality of application virtual machines are instantiated on the hypervisor. Each of the plurality of application virtual machines executes at least one licensed software application and a local license manager for managing a license file of the licensed software application. A master license manager executes on the physical machine. The master license manager is configured to receive the license files of the licensed software application from the local license managers of each of the plurality of application virtual machines.

The hypervisor may operate directly on the computer system hardware. The hypervisor may operate on a host operating system that is installed on the computer system hardware. The local license managers for each of the plurality of application virtual machines may be in communication with the master license manager over a virtual network maintained by the hypervisor. The master license manager may be run within a master license manager virtual machine instantiated on the hypervisor. The master license manager may be run upon the host operating system. The master license manager may be further configured to use the license files of the licensed software applications transferred from the local license managers of the plurality of application virtual machines to reply to inquiries originated by the local license managers concerning the use of the licensed software applications. The local license managers may be configured to collect identifying information concerning their respective application virtual machines and pass this identifying information to the master license manager. The master license manager may be configured to collect identifying information concerning the physical machine and bind the identifying information concerning the virtual machines and the identifying information concerning the physical machine to the license file of the licensed software application.

A method for managing software application licenses includes determining, by a local license manager, whether the local license manager is running within a virtual machine instantiated on a hypervisor running on a physical machine including computer system hardware. A license file for controlling access to a software application also running on the virtual machine is transferred to a master license manager running on the physical machine when it is determined that the local license manager is running within the virtual machine. Access to the software application is controlled using the transferred license file.

The local license manager may determine that it is running within the virtual machine by communicating with the hypervisor. When it is determined that the local license manager is not running within the virtual machine, the license file might not be transferred and access to the software application may be controlled using the not-transferred license file. The transferring of the license file from the local license manager to the master license manager may be performed over a virtual network maintained by the hypervisor and the controlling of access to the software application may include the local license manager communicating with the master license manager over the virtual network. The license file may be transferred back to the local license manager from the master license manager upon the initiation of an administrator utilizing a graphical user interface running on the physical machine. Controlling access to the software application using the transferred license file may include receiving, by the local license manager, an inquiry from the software application concerning whether the software application may be utilized. The inquiry may be forwarded from the local license manager to the master license manager. A reply to the inquiry may be generated by the master license manager using the transferred license file and the reply may be sent to the local license manager. The utilization of the software application may be authorized by the local license manager upon receiving the reply from the master license manager. The local license manager may collect identifying information concerning the virtual machine, pass the collected identifying information concerning the virtual machine to the master license manager. The master license manager may identify information concerning the physical machine and bind the identifying information concerning the virtual machine and the identifying information concerning the physical machine to the transferred license file.

A system for managing software application licenses includes a physical machine including computer system hardware. A hypervisor operates on the physical machine. A plurality of application virtual machines are instantiated on the hypervisor. Each of the plurality of application virtual machines executes at least one licensed software application and a local license manager for managing a license file of the licensed software application. A master license manager executes on the physical machine. The master license manager is configured to receive identifying information concerning the application virtual machines from the local license managers. Identifying information concerning the physical machine is collected and the identifying information concerning the virtual machines and the identifying information concerning the physical machine are bound to the license file of the licensed software application.

A computer system includes a processor and a non-transitory, tangible, program storage medium, readable by the computer system, embodying a program of instructions executable by the processor to perform method steps for managing software application licenses. The method includes determining, by a local license manager, whether the local license manager is running within a virtual machine instantiated on a hypervisor running on a physical machine including computer system hardware. When it is determined that the local license manager is running within the virtual machine, a license file for controlling access to a software application also running on the virtual machine is transferred to a master license manager running on the physical machine. Access to the software application is then controlled using the transferred license file.

The method may further include the local license manager collecting identifying information concerning the virtual machine and passing the collected identifying information concerning the virtual machine to the master license manager. The master license manager may collect identifying information concerning the physical machine and bind the identifying information concerning the virtual machine and the identifying information concerning the physical machine to the transferred license file.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a schematic diagram illustrating a system for license management in a virtualization environment in accordance with exemplary embodiments of the present invention;

FIG. 2 is a schematic diagram illustrating an approach for implementing a license management system in accordance with exemplary embodiments of the present invention;

FIG. 3 is a flow chart illustrating an approach for license management in a virtualization environment in accordance with exemplary embodiments of the present invention; and

FIG. 4 shows an example of a computer system capable of implementing the method and apparatus according to embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention provide a system and approach for license management within a virtualization environment. These exemplary embodiments may be described herein in terms of a file based license management system in which the computer stores a license file and runs a license manager to verify the validity of the stored license file, however, exemplary embodiments of the present invention are not limited thereto and may be expanded to other approaches for license management such as a hardware dongle or license server. As used herein, the license manager (LM) may be a software management tool used by software vendors to control where and how software products are able to run. On each machine, physical or virtual, where the software product is installed, one license manager may be installed to control access to the software with reference to one or more license files.

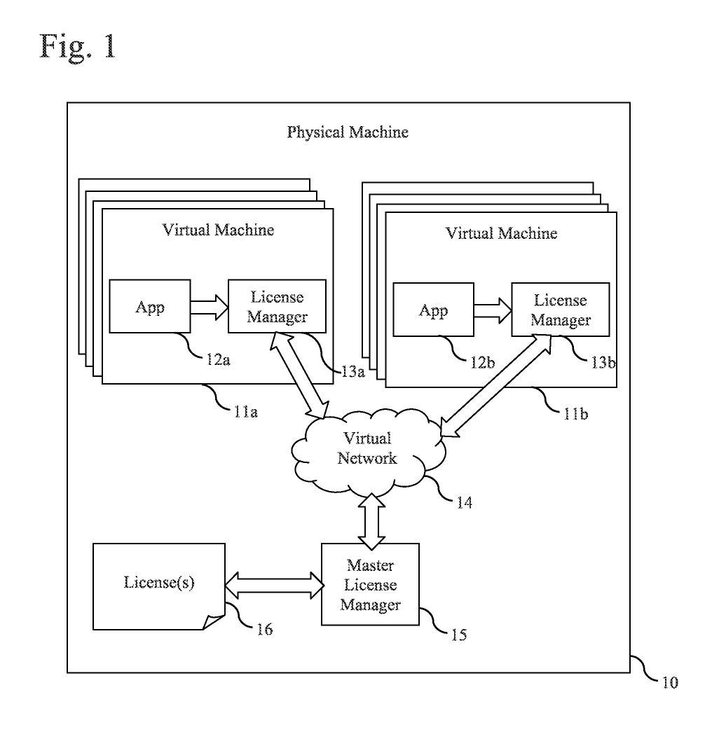

FIG. 1 is a schematic diagram illustrating a system for license management in a virtualization environment in accordance with exemplary embodiments of the present invention. A single physical machine 10 may run one or more virtual machines 11 {11a, 11b, . . . } thereon. The single physical machine 10 may run an operating system and a hypervisor may be run upon the operating system. In this case the hypervisor may be classified as a “type 1” hypervisor.

Alternatively, the hypervisor may run directly on the physical machine 10 without the use of an intervening operating system running directly on the physical machine. In this case, the hypervisor may be classified as a “type 2” hypervisor. The operating system may manage interaction between the hypervisor and the hardware elements of the physical machine 10. Each virtual machine 11 may run on the hypervisor. The hypervisor may establish, for each VM 11, virtual hardware and the resources of the physical machine may be made available to the virtual hardware of each VM 11 through the hypervisor.

Each VM 11 may include a copy of the software application 12 {12a, 12b, . . . } whose license rights are being managed and a license manager 13 {13a, 13b, . . . }. There may be multiple different software applications 12 installed on each VM 11 and all of the software applications 12 of the same VM 11 may share a common license manager 13. Alternatively, each software application 12 of the same VM 11 may have its own license manager 13.

The software applications 12 may contact their respective license managers 13 to validate the use of the software application 12 under the terms of the prevailing license. Each license manager 13 may consult with a master license manager 15 prior to validating software application 12 use. The master license manager (MLM) 15 may be a software management tool installed once on each physical machine where the physical machine also hosts one or more virtual machines thereon, each comprising a license manager. The single master license manager 15 may be installed on the physical machine 10, either directly on the hypervisor or physical machine operating system or the master license manager 15 may be installed on a dedicated virtual machine (e.g. a VM without a license manager 13). The single master license manager 15 may be used by the VM's license managers 13 to determine whether the software applications 12 are being used in accordance with licensing terms. The single master license manager 15 may call upon one or more license files 16 (colloquially referred to as licenses), which are stored locally to the physical machine 10 or readily accessible thereto (e.g. accessible in the absence of an Internet connection). The license files 16 may include a definition of license rights and the license files 16 may be encrypted and/or digitally signed. The master license manager 15 may contain software license files that belong to the license managers 13 of all the VMs 11.

The license managers 13 of the VMs 11 may each communicate with the master license manager 15 though a virtual network 14. The hypervisor may establish the virtual network 14 as a means of allowing the license managers 13 to communicate with the master license manager 15. The hypervisor may ensure that the virtual network 14 is accessible only within the physical machine 10 to prevent license managers of VMs running on different physical machines from contacting the master license manager 15. For example, if a VM 11 of the physical machine 10 is duplicated and then executed on a different physical machine, the duplicate will not be able to access the virtual network 14 and may therefore not be able to authenticate the application via the MLM 15 on the original physical machine 10.

The master license manager 15 may utilize a hardware signature for the actual hardware of the physical machine 10 and each of the license managers 13 may use this hardware signature in conjunction with the license files 16 to determine if the use of the applications 12 running on the VMs 11 is authorized. The license files 16 may receive the common hardware signature and they may also know that the applications 12 are being implemented on a virtual machine. For example, each license manager 13 may utilize APIs provided by the hypervisor to identify that they are being executed in a virtualization environment. The master license manager 15 may be aware of the number of virtual machines 11 requesting execution of the software applications 12 and may validate the particular usage with the license files 16. In this way, the license files 16 may allow the execution of the software applications 12 within the virtual environment but may also enforce limitations such as how many virtual machines 11 may execute the software application 12 at any given time.

As the license managers 13 may be able to detect that they are running in a virtualization environment, they may accordingly transfer any license files local to the VM down to the physical machine's collection of license files 16. In this way, a license management system may be able to work either directly on a physical machine (e.g. not through a hypervisor) or on a virtual machine, without the end-user having to appreciate a difference.

According to exemplary embodiments of the present invention, a master license manager control service (MLM CS) may be installed on the physical machine. The MLM CS may be used to retrieve comprehensive hardware and virtual machine fingerprints from the host and transfer this data to the master license manager for license fingerprinting. The MLM CS may also be responsible for starting the MLM and/or the LMs. Where the MLM is embodied on a dedicated VM, the MLM CS may initiate this dedicated VM. The MLM CS may also restart the MLM and/or LMs in the event they are shut down. The MLM CS may also be used to monitor the status of each of the LMs to detect activities such as cloning, creating snapshots, etc. and to inform the MLM so that the licenses may be protected. The MLM CS may either be embodied as a stand alone application or may be part of the MLM, especially where the MLM is deployed directly on the host machine.

A graphical user interface (GUI) may also be provided within the physical machine 10. The GUI may have full access rights to all licenses so that an administrator of the license management system may utilize the GUI to manage the license rights. The GUI may also be used to transfer back to a virtual machine, license files that have been previously transferred to the physical machines collection of license files 16 so that the particular virtual machine may be removed from the physical machine with its licenses intact.

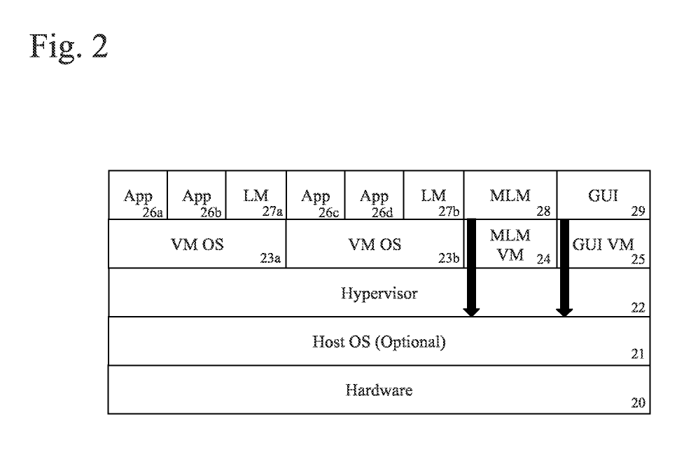

FIG. 2 is a schematic diagram illustrating an approach for implementing a license management system in accordance with exemplary embodiments of the present invention. The system may include one or more physical machines, with each physical machine being substantially as described herein. The physical machine includes hardware 20. The hardware 20 of the physical machine may include a microprocessor and other components generally found within a computer system. A host OS 21 may optionally be installed on the physical machine. A hypervisor 22 may either be installed on the host OS 21 (when the hypervisor 22 is a Type 1 hypervisor) or installed directly on the hardware 20 (when the hypervisor 22 is a Type 2 hypervisor). As there may be many different virtual machines installed on the hypervisor 22, the VM 11 is here referred to as an application VM to differentiate it from VMs established for other purposes.

One or more application VMs may be installed on the hypervisor 22. Each application VM may include a virtual machine operating system (VM OS) 23 ={23a, 23b, . . . }. Installed on the VM OSs 23 may be one or more applications 26={26a, 26b, 26c, 26d, . . . }. Each VM OS 23 may also have a license manager (LM) 27={27s, 27b, . . . } installed thereon. These license managers 27 may be referred to herein as local license managers (LLM) to distinguish them from the master license manager (MLM) 28 which is also installed.

The MLM 28 may be installed either directly on the Host OS 21, where a host OS is used, or it may be installed on its own virtual machine 24, which may be called the master license manager virtual machine (MLM VM) 24. Using an MLM VM may be particularly useful where no host OS 21 is used. The MLM 28 is installed once for each physical machine and its hardware 20. As discussed above, the MLM 28 is in communication with each of the local license managers (LLMs) 27 via the hypervisor 22 so that licenses from the LLMs 27 may be transferred to the control of the MLM 28.

A GUI 29, as discussed above, may also be installed once per physical machine and its hardware 20. As is the case with the MLM 28, the GUI 29 may either be installed directly on the host OS 21, where available, or may be installed on a GUI VM 25 dedicated to the task, the GUI VM 25, like the MLM VM, being executed by the hypervisor 22.

Although not shown, exemplary embodiments may also include a master license manager control system (MLM CS) which may be embodied as either part of the MLM or another entity. The MLM CS may be used to deploy the MLM, to retrieve comprehensive hardware and virtual machine fingerprints from the host physical machine and transfer these fingerprints to the MLM for license fingerprinting, to start and restart the MLM VM and/or MLM, and to monitor the status of the MLM and/or MLM VM, for example, to determine if a virtual machine is being cloned, snapshotted, and other activity that may violate the terms of the software license and report this activity to the MLM. According to some exemplary embodiments of the present invention, the MLM CS can be integrated as part of the MLM when it is deployed directly on the host machine.

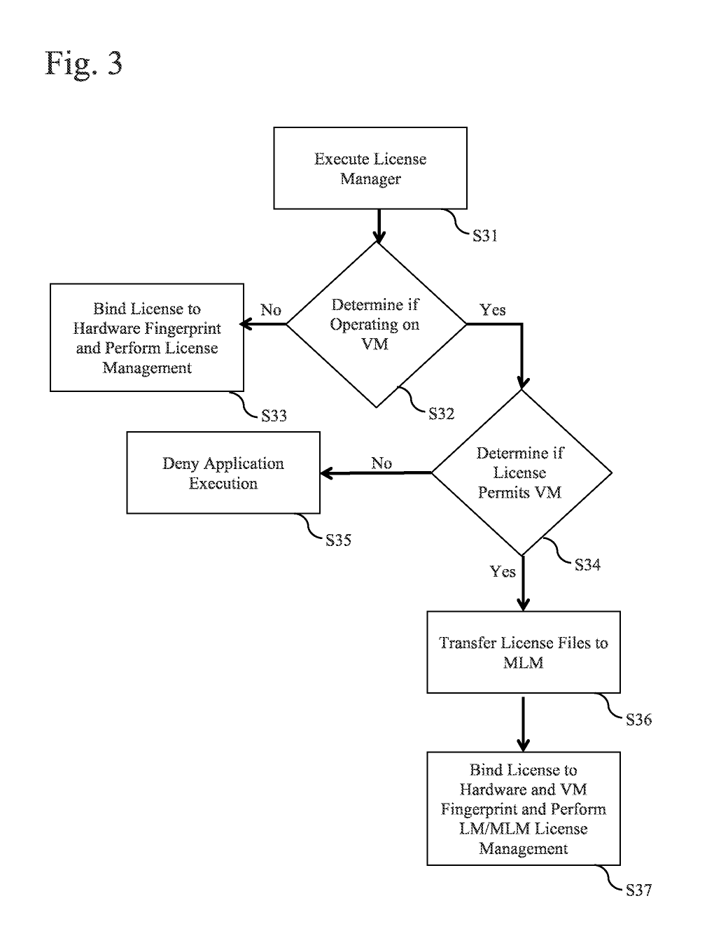

FIG. 3 is a flow chart illustrating an approach for license management in a virtualization environment in accordance with exemplary embodiments of the present invention. This approach may be used in conjunction with the system described above. First, a local license manager may be started (Step S31). Starting of the local license manager may be performed within an application VM as discussed above and may occur directly as a result of installing the licensed software application on the application VM. The starting of the local license manager may also be performed by a GUI such as the GUI discussed above.

Thereafter, it may be determined whether the local license manager is operating on a VM or directly on hardware (Step S32). As mentioned above, this determination may be made by utilizing, or attempting to utilize, APIs provided by the hypervisor, should one be present. If the LLM is operated directly on hardware (No, Step S32) then the LLM may perform like a stand-alone license manager and may bind the license to hardware fingerprints and perform license management (Step S33). Alternatively, if the LLM is operated within a VM (Yes, Step S32), then the LLM may begin virtualization environment operation, for example, as described above. This may include determining if the license terms permit operation on a VM (Step S34). If it does not (No, Step S34), then application execution may be denied (Step S35). If, however, the terms of the license allow for execution within a virtualization environment (Yes, Step S34), then license files may be transferred from the VM down to the domain of the MLM (Step S36). This may include, for example, determining the location of the MLM. Exemplary embodiments of the present invention may have the ability to relocate the MLM in the event that it is moved elsewhere within the physical machine so that communication between the LLM and the MLM may be maintained.

As the MLM may itself operate within a VM, for example, the MLM VM, the license may be transferred from one VM to another. However, the domain of the MLM is distinct from that of the LLM in that there may be a plurality of application VMs running on the physical machine, which each application VM running a LLM and all of the LLMs of the physical machine are transferring their licenses to the domain of the MLM. Accordingly, the licenses may be transferred from a plurality of locations, under the control of a plurality of LLMs to a single location under the control of a single MLM.

Once the license(s) are transferred to the MLM, the licenses may be bound to fingerprints of the hardware as well as to fingerprints of the corresponding application VMs (Step S37). Thereafter, license management may be performed by the LLMs in conjunction with the MLM.

Performance of license management may include a LLM receiving a license inquiry from its corresponding software application. The license inquiry is a request by the software application to determine if its use is sanctioned under the terms of the license. The LLM may then forward the inquiry to the MLM, for example, along with a unique identification designating the particular LLM forwarding the inquiry. The MLM may then process the inquiry, accessing the stored license files using the LLM ID, and may then send a reply to the LLM. The LLM may then modify the reply to translate the location of the licenses at the MLM to the local location and then use the modified reply to reply to the software application.

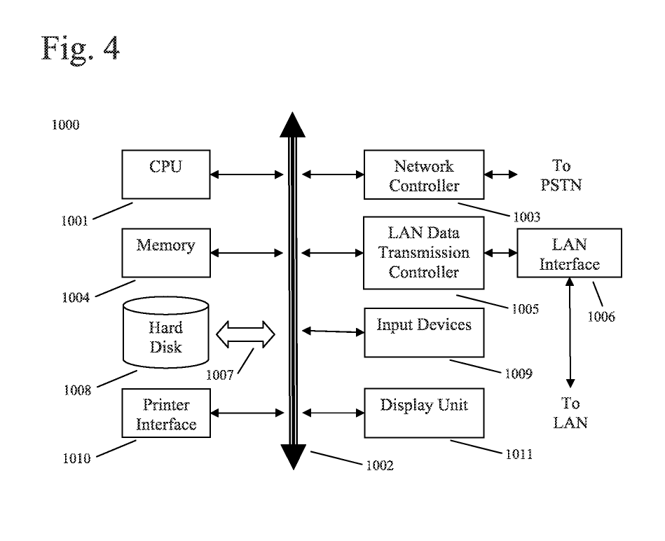

FIG. 4 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A system for managing software application licenses, comprising:
a physical machine including computer system hardware;
a hypervisor operating on the physical machine;
a plurality of application virtual machines instantiated on the hypervisor, each of the plurality of application virtual machines executing at least one licensed software application and a local license manager for managing a license file of the licensed software application; and
a master license manager executing on the physical machine, the master license manager configured to receive the license files of the licensed software application from the local license managers of each of the plurality of application virtual machines.

2. The system of claim 1, wherein the hypervisor operates directly on the computer system hardware.

3. The system of claim 1, wherein the hypervisor operates on a host operating system that is installed on the computer system hardware.

4. The system of claim 1, wherein the local license managers for each of the plurality of application virtual machines is in communication with the master license manager over a virtual network maintained by the hypervisor.

5. The system of claim 1, wherein the master license manager is run within a master license manager virtual machine instantiated on the hypervisor.

6. The system of claim 3, wherein the master license manager is run upon the host operating system.

7. The system of claim 1, wherein the master license manager is further configured to use the license files of the licensed software applications transferred from the local license managers of the plurality of application virtual machines to reply to inquiries originated by the local license managers concerning the use of the licensed software applications.

8. The system of claim 1, wherein the local license managers are configured to collect identifying information concerning their respective application virtual machines and pass this identifying information to the master license manager and the master license manager is configured to collect identifying information concerning the physical machine and bind the identifying information concerning the virtual machines and the identifying information concerning the physical machine to the license file of the licensed software application.

9. A method for managing software application licenses, comprising:
determining, by a local license manager, whether the local license manager is running within a virtual machine instantiated on a hypervisor running on a physical machine including computer system hardware;
transferring, to a master license manager running on the physical machine, a license file for controlling access to a software application also running on the virtual machine, when it is determined that the local license manager is running within the virtual machine; and
controlling access to the software application using the transferred license file.

10. The method of claim 9, wherein the local license manager determines that it is running within the virtual machine by communicating with the hypervisor.

11. The method of claim 9, wherein when it is determined that the local license manager is not running within the virtual machine, the license file is not transferred and access to the software application is controlled using the not-transferred license file.

12. The method of claim 9, wherein the transferring of the license file from the local license manager to the master license manager is performed over a virtual network maintained by the hypervisor and the controlling of access to the software application includes the local license manager communicating with the master license manager over the virtual network.

13. The method of claim 9, wherein the license file is transferred back to the local license manager from the master license manager upon the initiation of an administrator utilizing a graphical user interface running on the physical machine.

14. The method of claim 9, wherein controlling access to the software application using the transferred license file, comprises:
receiving, by the local license manager, an inquiry from the software application concerning whether the software application may be utilized;
forwarding the inquiry from the local license manager to the master license manager;
generating a reply to the inquiry, at the master license manager, using the transferred license file and sending the reply to the local license manager; and
authorizing the utilization of the software application, by the local license manager, upon receiving the reply from the master license manager.

15. The method of claim 9, additionally comprising:
collecting, by the local license manager, identifying information concerning the virtual machine;
passing the collected identifying information concerning the virtual machine to the master license manager;
collecting, by the master license manager, identifying information concerning the physical machine; and
binding, by the master license manager, the identifying information concerning the virtual machine and the identifying information concerning the physical machine to the transferred license file.

16. A system for managing software application licenses, comprising:
a physical machine including computer system hardware;
a hypervisor operating on the physical machine;
a plurality of application virtual machines instantiated on the hypervisor, each of the plurality of application virtual machines executing at least one licensed software application and a local license manager for managing a license file of the licensed software application; and
a master license manager executing on the physical machine, the master license manager configured to receive identifying information concerning the application virtual machines from the local license managers, collect identifying information concerning the physical machine, and bind the identifying information concerning the virtual machines and the identifying information concerning the physical machine to the license file of the licensed software application.

17. A computer system comprising:
a processor; and
a non-transitory, tangible, program storage medium, readable by the computer system, embodying a program of instructions executable by the processor to perform method steps for managing software application licenses, the method comprising:
determining, by a local license manager, whether the local license manager is running within a virtual machine instantiated on a hypervisor running on a physical machine including computer system hardware;
transferring, to a master license manager running on the physical machine, a license file for controlling access to a software application also running on the virtual machine, when it is determined that the local license manager is running within the virtual machine; and
controlling access to the software application using the transferred license file.

18. The computer system of claim 19, wherein the method further comprises:
collecting, by the local license manager, identifying information concerning the virtual machine;
passing the collected identifying information concerning the virtual machine to the master license manager;
collecting, by the master license manager, identifying information concerning the physical machine; and
binding, by the master license manager, the identifying information concerning the virtual machine and the identifying information concerning the physical machine to the transferred license file.
